(19) United States
(12) Patent Application Publication
(10) Pub. No.: US 2021/0263263 A1
(43) Pub. Date: Aug. 26, 2021

(54) CAMERA LENS

(71) Applicant: AAC Optics Solutions Pte. Ltd., Singapore city (SG)

(72) Inventor: Takaaki Teranishi, OSAKA (JP)

(21) Appl. No.: 16/816,291

(22) Filed: Mar. 12, 2020

(30) Foreign Application Priority Data
Feb. 25, 2020 (JP) 2020-029440

(51) Int. Cl. G02B 9/60; G02B 13/18

(52) U.S. Cl. CPC G02B 9/60; G02B 13/18

(57) ABSTRACT

The present invention provides a camera lens consisting of five lenses and having good optical properties in near-infrared light, a small size and a bright F number. The camera lens includes, from an object side, a first lens having a positive refractive power, a second lens having a negative refractive power, a third lens having a positive refractive power, a fourth lens having a negative refractive power, and a fifth lens having a negative refractive power. The camera lens satisfies specific conditions.

### TECHNICAL FIELD

The present invention relates to a camera lens, and particularly, to a camera lens, which is suitable for a driver monitoring system or indoor monitoring system for monitoring people, consists of five lenses, and has good optical properties in near-infrared light, a small size and a bright F number (denoted as Fno hereafter).

### BACKGROUND

In recent years, in a driver monitoring system for automatic driving, a warning system has been developed and is configured to detect a driver's head movement, eyelid opening condition, sight direction, and behaviors (smoking/calling) from images obtained by shooting the driver and send a warning. In addition, in an indoor monitoring system, a system has also been developed and is configured to detect postures of occupants in the back seat, the presence or absence of a crib, and accidental remove of a child's seat belt and send a warning. In these monitoring systems, it is required to provide a camera lens that has good optical properties under infrared rays for monitoring the driver/occupant, has a small size for reducing the sense of presence of the camera, and has a bright Fno for clearly monitoring even at night.

A camera lens disclosed in the prior art provides a camera lens, which consists of a first lens having a positive refractive power, a second lens having a negative refractive power, a third lens having a positive refractive power, and a fourth lens having a positive refractive power. However, in this camera lens, TTL (a total optical length)/f (a focal length of the camera lens) is greater than or equal to 1.49, which is insufficient in terms of miniaturization.

### SUMMARY

A purpose of the present invention is to provide a camera lens, which consists of five lenses and has good optical properties in near-infrared light, a small size and a bright Fno.

For the above purpose, in the camera lens including, from an object side, a first lens having a positive refractive power, a second lens having a negative refractive power, a third lens having a positive refractive power, a fourth lens having a negative refractive power, and a fifth lens having a negative refractive power. Applicant has intensively studied a range of a refractive index of d line of the first lens, a relation between a center thickness of the first lens and a focal length of the camera lens, a relation among the refractive index of d line of the first lens, a curvature radius of an object side surface of the first lens and the focal length of the camera lens, as well as a relation among the refractive index of d line of the first lens, a curvature radius of an image side surface of the first lens and the focal length of the camera lens. The results indicate that the camera lens of the present invention can solve the technical problems in the related art.

A camera lens according to a first technical solution is characterized in that, the camera lens includes, from an object side, a first lens having a positive refractive power, a second lens having a negative refractive power, a third lens having a positive refractive power, a fourth lens having a negative refractive power, and a fifth lens having a negative refractive power. The camera lens satisfies following conditions:

1.75≤nd1≤1.84;

0.195≤d1/f≤0.210;

0.200≤(nd1/R1)/f≤0.210; and

0.035≤(nd1/R2)/f≤0.060,
where nd1 denotes a refractive index of d line of the first lens;
d1 denotes a center thickness of the first lens;
f denotes a focal length of the camera lens;
R1 denotes a curvature radius of an object side surface of the first lens; and
R2 denotes a curvature radius of an image side surface of the first lens.

The camera lens according to a second technical solution further satisfies following conditions:

0.50≤f1/f≤0.60; and

−1.10≤f2/f≤−1.00

where f denotes a focal length of the camera lens;

f1 denotes a focal length of the first lens; and

f2 denotes a focal length of the second lens.

According to the present invention, provided is a camera lens suitable for driver monitoring or indoor monitoring, and the camera lens consists of five lenses and has good optical properties in near-infrared light, a small size and a bright Fno.

### BRIEF DESCRIPTION OF DRAWINGS

FIG. 1 is a schematic diagram of a camera lens LA according to a first embodiment of the present invention;

FIG. 2 is diagrams of a spherical aberration, a field curvature, a distortion of the camera lens LA according to the first embodiment of the present invention;

FIG. 3 is a schematic diagram of a camera lens LA according to a second embodiment of the present invention;

FIG. 4 is diagrams of a spherical aberration, a field curvature, a distortion of the camera lens LA according to the second embodiment of the present invention;

FIG. 5 is a schematic diagram of a camera lens LA according to a third embodiment of the present invention;

FIG. 6 is diagrams of a spherical aberration, a field curvature, a distortion of the camera lens LA according to the third embodiment of the present invention;

FIG. 7 is a schematic diagram of a camera lens LA according to a fourth embodiment of the present invention; and

FIG. 8 is diagrams of a spherical aberration, a field curvature, a distortion of the camera lens LA according to the fourth embodiment of the present invention.

### DESCRIPTION OF EMBODIMENTS

The embodiments of the camera lens according to the present invention will be described below. The camera lens LA is provided with a lens system. The lens system is a five-lens structure and includes a first lens L1, a second lens L2, a third lens L3, a fourth lens L4, and a fifth lens L5 that are arranged from an object side to an image side. A glass plate GF is arranged between the fifth lens L5 and an image plane. A cover glass plate and various filters can be considered as the glass flat plate GF. In the present invention, the glass plate GF may be arranged at different positions, or may also be omitted.

The first lens L1 is a lens having a positive refractive power, the second lens L2 is a lens having a negative refractive power, the third lens L3 is a lens having a positive refractive power, the fourth lens L4 is a lens having a negative refractive power, and the fifth lens L5 is a lens having a negative refractive power. In order to correct various aberrations, it is desirable to design all surfaces of these five lenses as aspherical surfaces.

The camera lens LA satisfies the following conditions (1) to (4):

1.75≤nd1≤1.84 (1);

0.195≤d1/f≤0.210 (2);

0.200≤(nd1/R1)/f≤0.210 (3); and

0.035≤(nd1/R2)/f≤0.060 (4),
where nd1 denotes a refractive index of d line of the first lens L1;
d1 denotes a center thickness of the first lens L1;
f denotes a focal length of the camera lens;
R1 denotes a curvature radius of an object side surface of the first lens L1; and
R2 denotes a curvature radius of an image side surface of the first lens L1.

The condition (1) specifies the refractive index nd1 of d line of the first lens L1. If it is smaller than the lower limit of condition (1), the refractive index is relatively small, which is not preferable in terms of miniaturization. On the other hand, if it is greater than the upper limit, the positive refractive power is such great that the spherical aberration and coma are hardly to be corrected, which is not preferable.

The condition (2) specifies a relation between the center thickness d1 of the first lens L1 and the focal length f of the camera lens LA. If it is smaller than the lower limit of condition (2), the spherical aberration and coma are hardly to be corrected, which is not preferable in terms of brightening Fno. On the other hand, it is not preferable for the miniaturization if it is greater than the upper limit.

By satisfying the conditions (3) and (4), the camera lens, which consists of five lenses and has good optical properties in near-infrared light, a small size and a bright Fno, can be obtained.

The condition (3) specifies a positive refractive power distribution of the curvature radius R1 of the object side surface of the first lens L1, and the condition (4) specifies a negative refractive power distribution of the curvature radius R2 of the image side surface of the first lens L1. Within the ranges of the conditions (3) and (4), the positive and negative refractive power distributions of R1 and R2 fail to be optimized, and thus the miniaturization and the brightening of Fno are difficult, which is not preferable.

The camera lens further satisfies following conditions (5) to (6):

0.50≤f1/f≤0.60 (5); and

−1.10≤f2/f≤−1.00 (6),
where f denotes the focal length of the camera lens;
f1 denotes a focal length of the first lens; and
f2 denotes a focal length of the second lens.

The condition (5) specifies a relation between the focal length f1 of the first lens L1 and the focal length f of the camera lens. By limiting the focal length of the first lens within the range of condition (5), the miniaturization can be achieved, and the spherical aberration and coma can be well corrected.

If it is smaller than the upper limit of the condition (5), the refractive power of the first lens will not be too weak, which is conducive to the miniaturization. On the other hand, if it is greater than the lower limit, the refractive power of the first lens will not be too strong, which is advantageous for the miniaturization, and the spherical aberration and coma can be easily corrected.

The condition (6) specifies a relation between the focal length f2 of the second lens L2 and the focal length f of the camera lens. If it is greater than the lower limit of the condition (6), the refractive power of the second lens will not be insufficient, and thus aberrations can be easily and sufficiently corrected. On the other hand, if it is smaller than the upper limit, the refractive power of the second lens will not be too strong, the spherical aberration and coma can be easily corrected, and an error sensitivity during manufacturing will not become strict.

If the five lenses of the camera lens LA satisfy the above construction and conditions, the camera lens, which consists of five lenses and has good optical properties in near-infrared light, a small size of TTL/f≤1.25 and a bright Fno, can be obtained.

The camera lens LA of the present invention will be described with reference to the embodiments below. The reference signs described in the embodiments are listed below.

In addition, the distance, radius and center thickness are all in a unit of mm.

f: focal length of the camera lens LA;

f1: focal length of the first lens L1;

f2: focal length of the second lens L2;

f3: focal length of the third lens L3;

f4: focal length of the fourth lens L4;

f5: focal length of the fifth lens L5;

Fno: F number;

2ω: full field of view;

STOP: aperture;

R: curvature radius of an optical surface, a central curvature radius for a lens;

R1: curvature radius of the object side surface of the first lens L1;

R2: curvature radius of the image side surface of the first lens L1;

R3: curvature radius of an object side surface of the second lens L2;

R4: curvature radius of an image side surface of the second lens L2;

R5: curvature radius of an object side surface of the third lens L3;

R6: curvature radius of an image side surface of the third lens L3;

R7: curvature radius of an object side surface of the fourth lens L4;

R8: curvature radius of an image side surface of the fourth lens L4;

R9: curvature radius of an object side surface of the fifth lens L5;

R10: curvature radius of an image side surface of the fifth lens L5;

R11: curvature radius of an object side surface of a glass plate GF1;

R12: curvature radius of an image side surface of a glass plate GF1;

R13: curvature radius of an object side surface of a glass plate GF2;

R14: curvature radius of an image side surface of a glass plate GF2;

d: center thickness or distance between lenses;

d0: on-axis distance from the aperture STOP to the object side surface of the first lens L1;

d1: center thickness of the first lens L1;

d2: on-axis distance from the image side surface of the first lens L1 to the object side surface of the second lens L2;

d3: center thickness of the second lens L2;

d4: on-axis distance from the image side surface of the second lens L2 to the object side surface of the third lens L3;

d5: center thickness of the third lens L3;

d6: on-axis distance from the image side surface of the third lens L3 to the object side surface of the fourth lens L4;

d7: center thickness of the fourth lens L4;

d8: on-axis distance from the image side surface of the fourth lens L4 to the object side surface of the fifth lens L5;

d9: center thickness of the fifth lens L5;

d10: on-axis distance from the image side surface of the fifth lens L5 to the object side surface of the glass plate GF;

d11: center thickness of the glass plate GF1;

d12: on-axis distance from the image side surface of the glass plate GF1 to the object side surface of the glass plate GF;

d13: center thickness of the glass plate GF2;

d14: on-axis distance from the image side surface of the glass plate GF2 to the image plane;

nd: refractive index of d line;

nd1: refractive index of d line of the first lens L1;

nd2: refractive index of d line of the second lens L2;

nd3: refractive index of d line of the third lens L3;

nd4: refractive index of d line of the fourth lens L4;

nd5: refractive index of d line of the fifth lens L5;

nd6: refractive index of d line of the glass plate GF1;

nd7: refractive index of d line of the glass plate GF2;

v: abbe number;

v1: abbe number of the first lens L1;

v2: abbe number of the second lens L2;

v3: abbe number of the third lens L3;

v4: abbe number of the fourth lens L4;

v5: abbe number of the fifth lens L5;

v6: abbe number of the glass plate GF1;

v7: abbe number of the glass plate GF2;

TTL: total optical length (on-axis distance from the object side surface of the first lens L1 to the image plane); and

LB: on-axis distance from the image side surface of the fifth lens L5 to the image plane (including the thickness of the glass plate GF).

y=(x²/R)/[1+{1−(k+1)(x2/R2)}^{1/2}]+A4x⁴+A6x⁶+A8x⁸+A10x¹⁰+A12x¹²+A14x¹⁴+A16x¹⁶ (7)

y=(x²/R)/[1+{1−(k+1)(x²/R²)}^{1/2}]+A4x⁴+A6x⁶+A8x⁸+A10x¹⁰+A12x¹²+A14x¹⁴+A16x¹⁶+A18x¹⁸+A20x²⁰ (7)

For convenience, the aspheric surface of each lens surface uses the aspheric surface defined in the equation (7). However, the present invention is not limited to the aspherical polynomial defined in the equation (7).

### First Embodiment

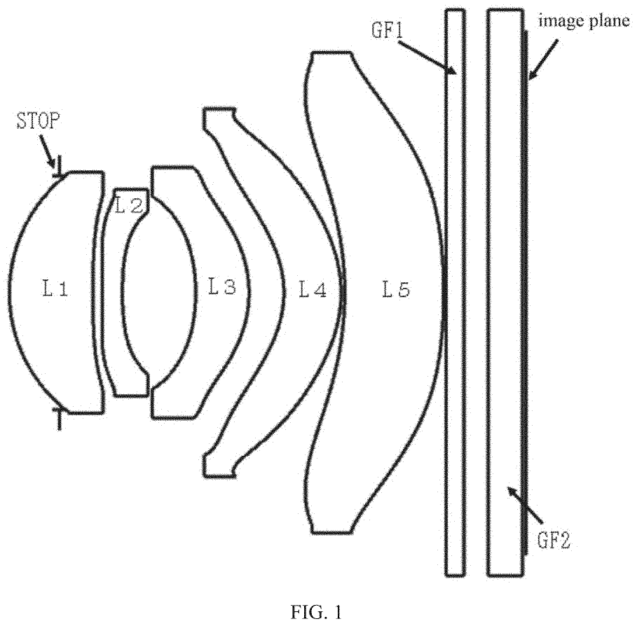

FIG. 1 is a schematic diagram of a camera lens LA according to a first embodiment of the present invention. The curvature radiuses R of the image side surfaces and object side surfaces of the first lens L1 to the fifth lens L5 of the camera lens LA according to the first embodiment, the center thicknesses of the lenses, or distances d between lenses, refractive indexes nd, abbe numbers v are shown in Table 1; conic coefficients k and aspheric coefficients are shown in Table 2; and 2ω, Fno, f, f1, f2, f3, f4, f5, TTL, and IH are shown in Table 3.

TABLE 1

| | R | d | | nd | | νd | | Effective radius (mm) |
|---|---|---|---|---|---|---|---|---|
| STOP | ∞ | d0 | −0.585 | | | | | 1.362 |
| R1 | 1.75092 | d1 | 0.972 | nd1 | 1.7503 | ν1 | 45.17 | 1.410 |
| R2 | 9.19519 | d2 | 0.115 | | | | | 1.179 |
| R3 | −7.23158 | d3 | 0.232 | nd2 | 1.5439 | ν2 | 55.95 | 1.210 |
| R4 | 4.40607 | d4 | 0.855 | | | | | 0.950 |
| R5 | −2.19427 | d5 | 0.622 | nd3 | 1.6355 | ν3 | 23.97 | 1.125 |
| R6 | −1.38188 | d6 | 0.408 | | | | | 1.464 |
| R7 | −1.21571 | d7 | 0.668 | nd4 | 1.6355 | ν4 | 23.97 | 1.900 |
| R8 | −1.50070 | d8 | 0.041 | | | | | 2.150 |
| R9 | −3.79732 | d9 | 1.154 | nd5 | 1.6355 | ν5 | 23.97 | 2.715 |
| R10 | −6.56292 | d10 | 0.030 | | | | | 2.805 |
| R11 | ∞ | d11 | 0.210 | nd6 | 1.5168 | ν6 | 64.17 | 3.200 |
| R12 | ∞ | d12 | 0.278 | | | | | 3.200 |
| R13 | ∞ | d13 | 0.400 | nd7 | 1.5168 | ν7 | 64.17 | 3.200 |
| R14 | ∞ | d14 | 0.045 | | | | | 3.300 |

Reference wavelength = 940 nm

TABLE 2

| | Conic coefficient | Aspherical coefficient | | | | | | |
|---|---|---|---|---|---|---|---|---|
| | k | A4 | A6 | A8 | A10 | A12 | A14 | A16 |
| R1 | −2.2731E−02 | −2.16 [symbol] 5E−04 | 2.17 [symbol] 4E−03 | −3.2 [symbol] 05E−03 | 1. [symbol] 107E−03 | 1.3 [symbol] 37E−04 | −7.1470E−05 | −1.0444E−04 |
| R2 | −1. [symbol] 473E+00 | 3. [symbol] 844E−03 | 2.367 [symbol] E−02 | 1.7 [symbol] 11E−02 | −3. [symbol] 120E−03 | −5.9748E−03 | −7.7 [symbol] E−04 | 1.0 [symbol] 2E−03 |
| R3 | −3.3839E+00 | 1.8 [symbol] 88E−01 | −5.23 [symbol] 8E−02 | 2.10 [symbol] 3E−02 | 2.1817E−02 | −1.3873E−03 | −1. [symbol] E−02 | 5.2377E−03 |
| R4 | 1.1111E+01 | 2.4002E−01 | −1.2734E−01 | 1.1138E−01 | 2.3 [symbol] 56E−02 | −7. [symbol] E−02 | 3.0 [symbol] 0E−02 | 1.3423E−02 |
| R5 | 1.417 [symbol] E+00 | −8.5712E−02 | 3.5 [symbol] 29E−02 | −1.4375E−01 | 2.1051E−01 | −3.8249E−02 | −1.05 [symbol] E−01 | 4.5 [symbol] 3E−02 |
| R6 | −8.6 [symbol] 73E−01 | 1.69 [symbol] E−02 | −3.1800E−02 | 2.8361E−02 | 1.5022E−02 | −3.5774E−03 | −3.26 [symbol] E−03 | 5.3 [symbol] 1E−04 |
| R7 | −1.2661E+00 | 2.5279E−02 | 7.782 [symbol] E−03 | −2.0363E−03 | 3.7244E−04 | [symbol] .8455E−05 | −5.5070E−07 | −1.2209E−05 |
| R8 | −5.8 [symbol] 18E−01 | 4.1 [symbol] 71E−02 | −2.2621E−03 | −3.3408E−04 | −8.351 [symbol] E−05 | −2.7917E−05 | 4.2809E−0 [symbol] | 3.472 [symbol] E−06 |
| R9 | −2.3 [symbol] 14E−01 | −8.5 [symbol] 05E−04 | 2.4 [symbol] 66E−03 | 3.3810E−06 | −1.6147E−05 | −7.5443E−0 [symbol] | 8.7 [symbol] E−08 | −4.1507E−10 |
| R10 | 3.9831E−01 | −2.2682E−02 | 1.2281E−03 | 1.9457E−04 | −1.0588E−06 | −2.1560E−06 | −1.5 [symbol] E−07 | 3.0781E−08 |

[symbol]

indicates data missing or illegible when filed

TABLE 3

| | |
|---|---|
| 2ω (°) | 62.70 |
| Fno | 1.80 |
| f (mm) | 4.903 |
| f1 (mm) | 2.790 |
| f2 (mm) | −5.080 |
| f3 (mm) | 4.716 |
| f4 (mm) | −95.672 |
| f5 (mm) | −17.469 |
| TTL (mm) | 6.030 |
| LB (mm) | 0.963 |
| IH (mm) | 3.093 |

The following Table 13 shows corresponding values of the parameters of the first to fourth embodiments defined in the conditions (1) to (6).

As shown in Table 13, the first embodiment satisfies the conditions (1) to (6).

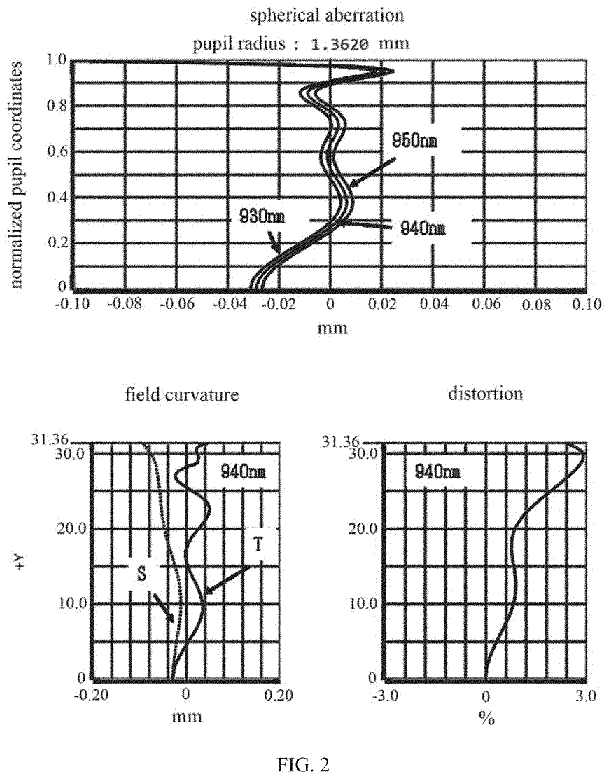

FIG. 2 illustrates a spherical aberration, a field curvature, and a distortion of the camera lens LA according to the first embodiment. In addition, in the figure, S is a field curvature for a sagittal image plane, and T is a field curvature for a meridional image plane, which are the same for the second to fourth embodiments. The camera lens LA according to the first embodiment has Fno=1.80 (i.e., bright), and TTL/f=1.23 (i.e., small in size), as shown in Table 3. Further, as shown in FIG. 2, the camera lens has good optical properties in near-infrared light.

### Second Embodiment

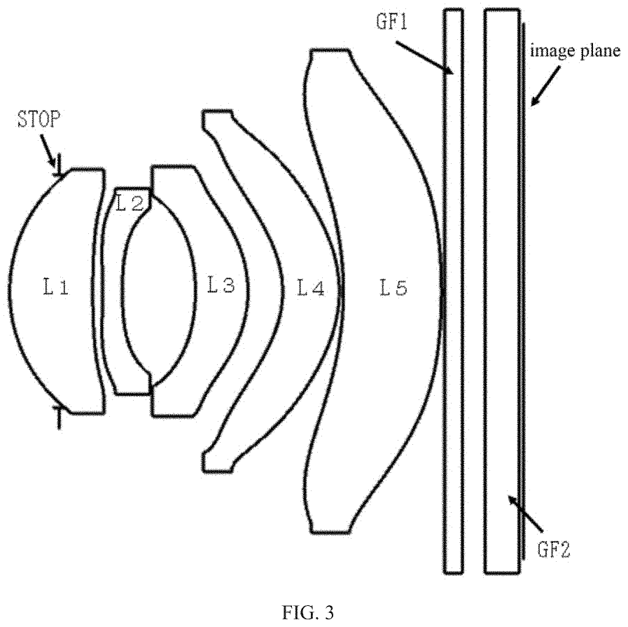

FIG. 3 is a schematic diagram of a camera lens LA according to a second embodiment of the present invention. The curvature radiuses R of the image side surfaces and object side surfaces of the first lens L1 to the fifth lens L5 of the camera lens LA according to the second embodiment, the center thicknesses of the lenses, or distances d between lenses, refractive indexes nd, abbe numbers v are shown in Table 4; conic coefficients k and aspheric coefficients are shown in Table 5; and 2ω, Fno, f, f1, f2, f3, f4, f5,TTL, and IH are shown in Table 6.

TABLE 4

| | R | d | | nd | | νd | | Effective radius (mm) |
|---|---|---|---|---|---|---|---|---|
| STOP | ∞ | d0 | −0.585 | | | | | 1.364 |
| R1 | 1.752 [symbol] 9 | d1 | 0.975 | nd1 | 1.7495 | ν1 | 35.26 | 1.429 |
| R2 | 9.33348 | d2 | 0.115 | | | | | 1.233 |
| R3 | −7.27879 | d3 | 0.232 | nd2 | 1.5439 | ν2 | 55.95 | 1.210 |
| R4 | 4.48902 | d4 | 0.857 | | | | | 0.975 |
| R5 | −2.17756 | d5 | 0.616 | nd3 | 1.6355 | ν3 | 23.97 | 1.125 |
| R6 | −1.38316 | d6 | 0.406 | | | | | 1.469 |
| R7 | −1.21311 | d7 | 0.665 | nd4 | 1.6355 | ν4 | 23.97 | 1.900 |
| R8 | −1.50092 | d8 | 0.046 | | | | | 2.110 |
| R9 | −3.81188 | d9 | 1.151 | nd5 | 1.6355 | ν5 | 23.97 | 2.715 |
| R10 | −6.55153 | d10 | 0.035 | | | | | 2.825 |
| R11 | ∞ | d11 | 0.210 | nd6 | 1.5168 | ν6 | 64.17 | 3.200 |
| R12 | ∞ | d12 | 0.270 | | | | | 3.200 |
| R13 | ∞ | d13 | 0.400 | nd7 | 1.5168 | ν7 | 64.17 | 3.200 |
| R14 | ∞ | d14 | 0.045 | | | | | 3.300 |

Reference wavelength = 940 nm [symbol]
indicates data missing or illegible when filed

TABLE 5

| | Conic coefficient | Aspherical coefficient | | | | | | |
|---|---|---|---|---|---|---|---|---|
| | k | A4 | A6 | A8 | A10 | A12 | A14 | A16 |
| R1 | −1.6353E−02 | −1.4622E−04 | 2.22 [symbol] E−03 | −3.3933E−03 | 1.8118E−03 | 1.6478E−04 | −6.2270E−05 | −1.1725E−04 |
| R2 | 3.2813E+00 | 4.8663E−03 | 2.1833E−02 | 2.1 [symbol] 05E−02 | −1.4562E−02 | −3.8995E−03 | −1.4477E−03 | 1.1864E−03 |
| R3 | −2.64 [symbol] 2E+00 | 1.8326E−01 | −5.0235E−02 | 2.1 [symbol] 5E−02 | 2.2323E−02 | − [symbol] .7297E−03 | −1. [symbol] E−02 | 4.3140E−03 |
| R4 | 1.1097E+01 | 2.4122E−01 | −1.3258E−01 | 1.1351E−01 | 2.8469E−02 | − [symbol] .5835E−02 | 3.1444E−02 | 8. [symbol] 1E−03 |
| R5 | 1.4301E+00 | − [symbol] .7 [symbol] 2E−02 | 3. [symbol] 537E−02 | −1.4422E−01 | 2.1146E−01 | −3.8533E−02 | −1.0600E−01 | 4.5900E−02 |
| R6 | −4.75 [symbol] 5E−01 | 1.5086E−02 | −3.1048E−02 | 2.8741E−02 | 1.5006E−02 | − [symbol] . [symbol] 774E−0 [symbol] | −3.3203E−03 | 6.6517E−04 |
| R7 | −1.2 [symbol] 49E+01 | 2.5255E−02 | 7.7524E−03 | −2.0430E−03 | 3.7276E−04 | 8.8079E−05 | −5.742 [symbol] E−07 | −1.2115E−05 |
| R8 | −5. [symbol] 43E−01 | 4.1881E−02 | −2.2538E−03 | −3. [symbol] 177E−04 | − [symbol] . [symbol] E−05 | −2.7727E−05 | 4.2954E−06 | 3.4542E−06 |
| R9 | −3.1 [symbol] 3E−01 | −3.8933E−04 | 2.4 [symbol] 7E−03 | 2.47 [symbol] 3E−06 | −1. [symbol] 146E−05 | −7. [symbol] 008E−08 | [symbol] .7186E−08 | −4. [symbol] E−10 |
| R10 | 4.0355E−01 | −2.2504E−02 | 1.22 [symbol] 3E−03 | 1.9316E−04 | −1.2520E−06 | −2.1630E−0 [symbol] | −1.5088E−07 | 8.1009E−08 |

[symbol]

indicates data missing or illegible when filed

TABLE 6

| | |
|---|---|
| 2ω (°) | 62.76 |
| Fno | 1.81 |
| f (mm) | 4.929 |
| f1 (mm) | 2.804 |
| f2 (mm) | −5.148 |
| f3 (mm) | 4.776 |
| f4 (mm) | −84.764 |
| f5 (mm) | −17.693 |
| TTL (mm) | 6.029 |
| LB (mm) | 0.960 |
| IH (mm) | 3.093 |

As shown in Table 13, the second embodiment satisfies the conditions (1) to (6).

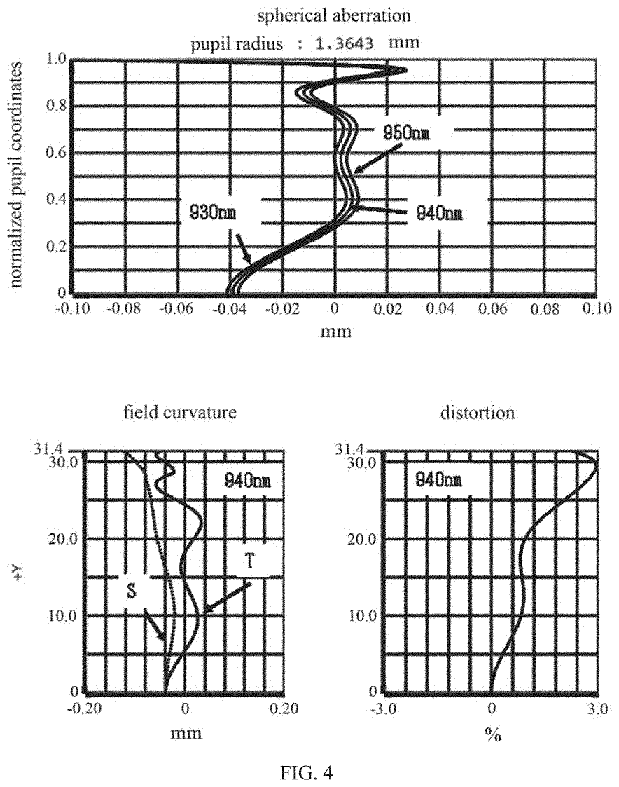

FIG. 4 illustrates a spherical aberration, a field curvature, and a distortion of the camera lens LA according to the second embodiment. The camera lens LA according to the second embodiment has Fno=1.81 (i.e., bright), and TTL/f=1.222 (i.e., small in size), as shown in Table 6. Further, as shown in FIG. 4, the camera lens has good optical properties in near-infrared light.

### Third Embodiment

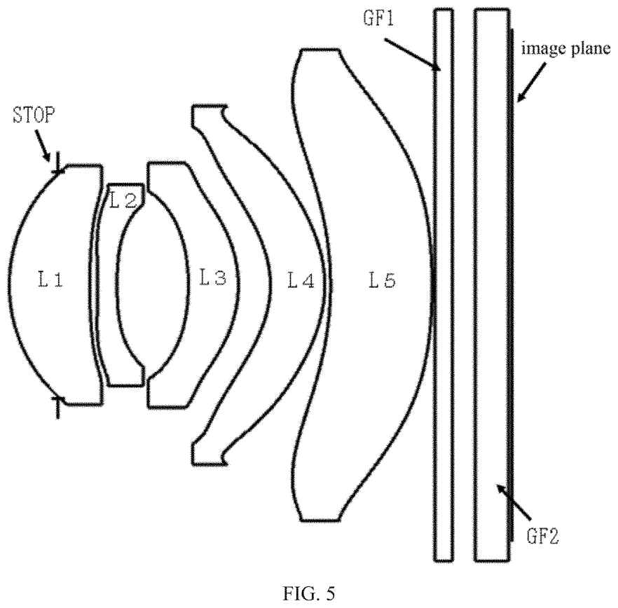

FIG. 5 is a schematic diagram of a camera lens LA according to a third embodiment of the present invention. The curvature radiuses R of the image side surfaces and object side surfaces of the first lens L1 to the fifth lens L5 of the camera lens LA according to the third embodiment, the center thicknesses of the lenses, or distances d between lenses, refractive indexes nd, abbe numbers v are shown in Table 7; conic coefficients k and aspheric coefficients are shown in Table 8; and 2ω, Fno, f, f1, f2, f3, f4, f5,TTL, and IH are shown in Table 9.

TABLE 7

| | R | d | | nd | | νd | | Effective radius (mm) |
|---|---|---|---|---|---|---|---|---|
| STOP | ∞ | d0 | −0.585 | | | | | 1.352 |
| R1 | 1.82180 | d1 | 0.964 | nd1 | 1.8344 | ν1 | 37.29 | 1.429 |
| R2 | 7.03629 | d2 | 0.095 | | | | | 1.233 |
| R3 | −7.01072 | d3 | 0.232 | nd2 | 1.5439 | ν2 | 55.95 | 1.210 |
| R4 | 4.39550 | d4 | 0.856 | | | | | 0.975 |
| R5 | −2.35401 | d5 | 0.599 | nd3 | 1.6355 | ν3 | 23.97 | 1.125 |
| R6 | −1.41993 | d6 | 0.384 | | | | | 1.461 |
| R7 | −1.23498 | d7 | 0.652 | nd4 | 1.6355 | ν4 | 23.97 | 1.900 |
| R8 | −1.51592 | d8 | 0.069 | | | | | 2.150 |
| R9 | −3.79582 | d9 | 1.218 | nd5 | 1.6355 | ν5 | 23.97 | 2.760 |
| R10 | −6.33746 | d10 | 0.035 | | | | | 2.820 |
| R11 | ∞ | d11 | 0.210 | nd6 | 1.5168 | ν6 | 64.17 | 3.200 |
| R12 | ∞ | d12 | 0-268 | | | | | 3.200 |
| R13 | ∞ | d13 | 0.400 | nd7 | 1.5168 | ν7 | 64.17 | 3.200 |
| R14 | ∞ | d14 | 0.045 | | | | | 3.300 |

Reference wavelength = 940 nm

TABLE 8

| | Conic coefficient | Aspherical coefficient | | | | | | |
|---|---|---|---|---|---|---|---|---|
| | k | A4 | A6 | A8 | A10 | A12 | A14 | A16 |
| R1 | −1. [symbol] E−02 | 2. [symbol] 705E−04 | 2.7784E−03 | −3.2440E−03 | 1.7 [symbol] 27E−03 | 1.0 [symbol] 7E−04 | −6.1450E−05 | −8.52 [symbol] E−05 |
| R2 | −1.1607E+00 | 4.2873E−03 | 2.312 [symbol] E−02 | 2.1 [symbol] 0E−02 | −1.45 [symbol] E−02 | −3. [symbol] 725E−03 | −1.632 [symbol] E−03 | 7.732 [symbol] E−04 |
| R3 | −3. [symbol] 173E+00 | 1. [symbol] 5E−01 | −5.4045E−02 | 2.174 [symbol] E−02 | 2.2973E−02 | − [symbol] .7375E−03 | −2.0530E−02 | 5. [symbol] 711E−03 |
| R4 | 1.067 [symbol] E+01 | 2.4 [symbol] 5E−01 | −1.311 [symbol] E−01 | [symbol] .7221E−02 | 1.8360E−02 | −7.0102E−02 | 3.14 [symbol] 3E−02 | 1.7 [symbol] 79E−02 |
| R5 | 1.541 [symbol] E+00 | −7.4157E−02 | 2.8825E−03 | −1.4 [symbol] 04E−01 | 2.1213E−01 | − [symbol] .25 [symbol] 9E−02 | −1.0567E−01 | 4.35 [symbol] 4E−02 |
| R6 | −4.7255E−01 | 1. [symbol] 7 [symbol] E−02 | −3. [symbol] E−02 | 2.7 [symbol] 40E−02 | 1.4 [symbol] 22E−02 | −3. [symbol] 277E−03 | −3.1 [symbol] 1E−03 | 6.5718E−04 |
| R7 | −1.2726E+00 | 2.4963E−02 | 7.847 [symbol] E−03 | −2.09 [symbol] 1E−03 | 3.4554E−04 | 5. [symbol] 11E−05 | −1. [symbol] 33E−08 | −1. [symbol] 7 [symbol] 2E−05 |
| R8 | − [symbol] . [symbol] E−01 | 4.1 [symbol] 5E−02 | −2. [symbol] 745E−03 | −4. [symbol] 0 [symbol] 0E−04 | −1.0 [symbol] 5E−04 | −2. [symbol] 5E−05 | 3.607 [symbol] E−06 | [symbol] .8649E−0 [symbol] |
| R9 | −2.7871E−01 | −7. [symbol] 41E−04 | 2.47 [symbol] E−03 | 4.4151E−06 | −1.5455E−05 | −8. [symbol] 21E−08 | 9.214 [symbol] E−08 | −2.2209E−0 [symbol] |
| R10 | 1. [symbol] 13E−01 | −2.22 [symbol] 2E−02 | 1.219 [symbol] E−03 | 1.8554E−04 | −1.4092E−06 | −2.240 [symbol] E−08 | −1.4 [symbol] 22E−07 | 3.2394E−0 [symbol] |

[symbol]

indicates data missing or illegible when filed

TABLE 9

| | |
|---|---|
| 2ω (°) | 69.21 |
| Fno | 1.80 |
| f (mm) | 4.873 |
| f1 (mm) | 2.790 |
| f2 (mm) | −4.970 |
| f3 (mm) | 4.693 |
| f4 (mm) | −91.654 |
| f5 (mm) | −18.876 |
| TTL (mm) | 6.026 |
| LB (mm) | 0.958 |
| IH (mm) | 3.093 |

As shown in Table 13, the third embodiment satisfies the conditions (1) to (6).

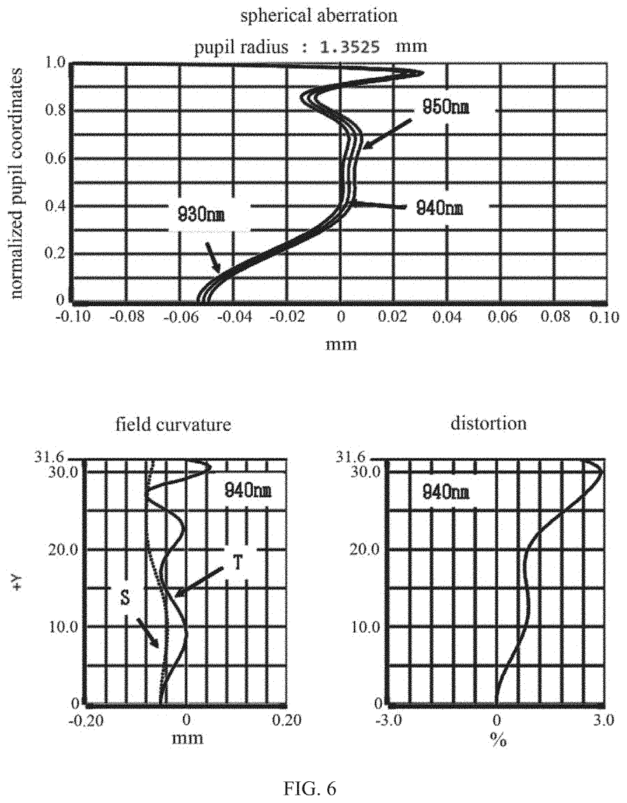

FIG. 6 illustrates a spherical aberration, a field curvature, and a distortion of the camera lens LA according to the third embodiment. The camera lens LA according to the third embodiment has Fno=1.80 (i.e., bright), and TTL/f=1.237 (i.e., small in size), as shown in Table 9. Further, as shown in FIG. 6, the camera lens has good optical properties in near-infrared light.

### Fourth Embodiment

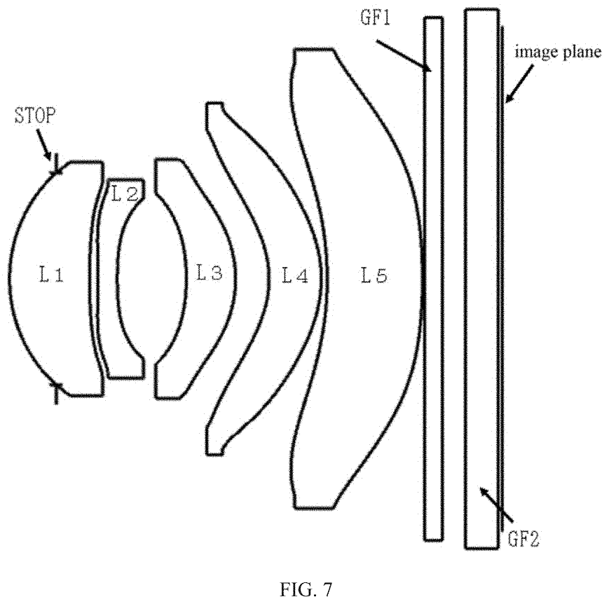

FIG. 7 is a schematic diagram of a camera lens LA according to a fourth embodiment of the present invention. The curvature radiuses R of the image side surfaces and object side surfaces of the first lens L1 to the fifth lens L5 of the camera lens LA according to the fourth embodiment, the center thicknesses of the lenses, or distances d between lenses, refractive indexes nd, abbe numbers v are shown in Table 10; conic coefficients k and aspheric coefficients are shown in Table 11; and 2ω, Fno, f, f1, f2, f3, f4, f5,TTL, and IH are shown in Table 12.

TABLE 10

| | R | d | | nd | | νd | | Effective radius (mm) |
|---|---|---|---|---|---|---|---|---|
| STOP | ∞ | d0 | −0.570 | | | | | 1.302 |
| R1 | 1.79000 | d1 | 0.976 | nd1 | 1.7880 | ν1 | 47.37 | 1.430 |
| R2 | 7.25438 | d2 | 0.106 | | | | | 1.233 |
| R3 | −7.08995 | d3 | 0.234 | nd2 | 1.5439 | ν2 | 55.95 | 1.214 |
| R4 | 4.22778 | d4 | 0.846 | | | | | 0.964 |
| R5 | −2.31617 | d5 | 0.603 | nd3 | 1.6355 | ν3 | 23.97 | 1.050 |
| R6 | −1.39499 | d6 | 0.409 | | | | | 1.468 |
| R7 | −1.27447 | d7 | 0.639 | nd4 | 1.6355 | ν4 | 23.97 | 1.625 |
| R8 | −1.54760 | d8 | 0.073 | | | | | 2.159 |
| R9 | −3.90728 | d9 | 1.165 | nd5 | 1.6355 | ν5 | 23.97 | 2.650 |
| R10 | −6.67400 | d10 | 0.030 | | | | | 2.812 |
| R11 | ∞ | d11 | 0.210 | nd6 | 1.5168 | ν6 | 64.17 | 3.200 |
| R12 | ∞ | d12 | 0.288 | | | | | 3.200 |
| R13 | ∞ | d13 | 0.400 | nd7 | 1.5168 | ν7 | 64.17 | 3.200 |
| R14 | ∞ | d14 | 0.045 | | | | | 3.300 |

Reference wavelength = 940 nm

TABLE 11

| | Conic coefficient | Aspherical coefficient | | | | | | |
|---|---|---|---|---|---|---|---|---|
| | k | A4 | A6 | A8 | A10 | A12 | A14 | A16 |
| R1 | −1.7359E−03 | 2.1483E−04 | 3.4740E−03 | −2. [symbol] 275E−03 | 1. [symbol] 086E−03 | 3.1374E−03 | − [symbol] .0292E−05 | −4.0527E−05 |
| R2 | 2.4850E+00 | 5.941E−03 | 2. [symbol] 40E−02 | 2.2 [symbol] 5E−02 | −1.32 [symbol] 1E−02 | −2.9352E−03 | −1.8226E−03 | 2.9977E−04 |
| R3 | −3.3520E−01 | 1.8151E−01 | −5.2733E−02 | 2. [symbol] 9E−02 | 2.0516E−02 | −1.04 [symbol] 7E−02 | −2.02 [symbol] E−02 | 2.5971E−03 |
| R4 | 1.00 [symbol] 1E+01 | 2.3637E−01 | −1.2821E−01 | 1.0201E−01 | 1.6257E−02 | −3.5 [symbol] 7 [symbol] E−02 | 1.0226E−02 | 4.4342E−02 |
| R5 | 1.4288E+00 | −7.507 [symbol] E−02 | 2.83 [symbol] 1E−02 | −1.370 [symbol] E−01 | 2.0021E−01 | −3.94 [symbol] E−02 | −1.02 [symbol] E−01 | 4.8465E−02 |
| R6 | −4. [symbol] 340E−01 | 2.157 [symbol] E−02 | −3.3162E−02 | 2.4 [symbol] 51E−02 | 1. [symbol] 2E−02 | −3.2 [symbol] 71E−03 | −2. [symbol] 24E−03 | 5.3793E−04 |
| R7 | −1.36 [symbol] 0E+00 | 2.7346E−02 | [symbol] .1 [symbol] 97E−03 | −2.3854E−03 | 1. [symbol] 23E−04 | 2.5004E−05 | 2.3813E−06 | −4.5 [symbol] E−06 |
| R8 | −5.5768E−01 | 4.4443E−02 | −2.7 [symbol] 0E−03 | −2.4902E−04 | −3. [symbol] 5 [symbol] E−05 | −2.1786E−05 | 3. [symbol] 22E−05 | 2.5280E−06 |
| R9 | −2. [symbol] 232E−01 | −3.1762E−04 | 2.41 [symbol] E−03 | −3.1 [symbol] 1E−07 | −1.6014E−05 | −1.4292E−07 | 8. [symbol] 4E−08 | −3. [symbol] 7E−11 |
| R10 | [symbol] . [symbol] 02 [symbol] E−01 | −2.2861E−02 | 1.2 [symbol] E−03 | 1. [symbol] 45E−04 | −1.1413E−08 | −2.1821E−08 | −1.4681E−07 | 2.80 [symbol] 7E−08 |

[symbol]

indicates data missing or illegible when filed

TABLE 12

| | |
|---|---|
| 2ω (°) | 64.36 |
| Fno | 1.87 |
| f (mm) | 4.869 |
| f1 (mm) | 2.856 |
| f2 (mm) | −4.967 |
| f3 (mm) | 4.637 |
| f4 (mm) | −101.885 |
| f5 (mm) | −18.478 |
| TTL (mm) | 6.024 |
| LB (mm) | 0.973 |
| IH (mm) | 3.093 |

As shown in Table 13, the fourth embodiment satisfies the conditions (1) to (6).

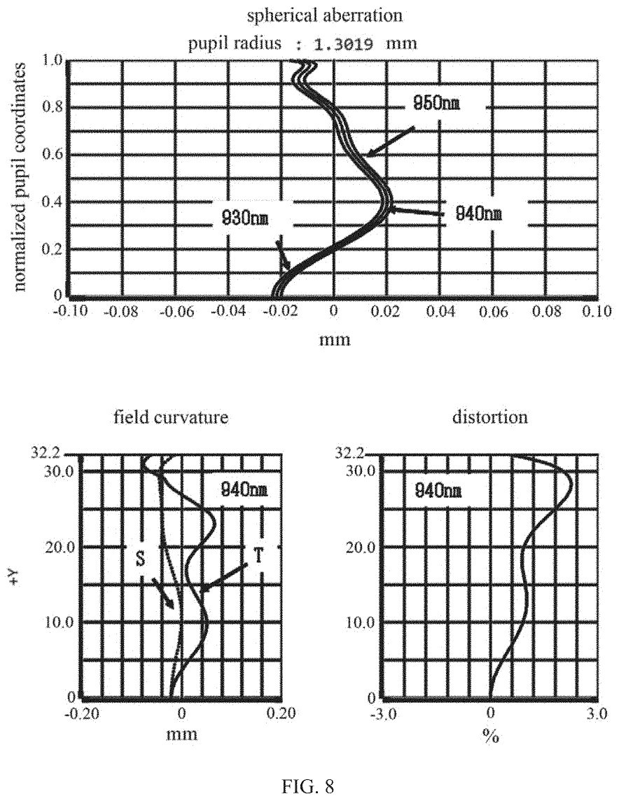

FIG. 8 illustrates a spherical aberration, a field curvature, and a distortion of the camera lens LA according to the fourth embodiment. The camera lens LA according to the fourth embodiment has Fno=1.87 (i.e., bright), and TTL/f=1.237 (i.e., small in size), as shown in Table 12. Further, as shown in FIG. 8, the camera lens has good optical properties in near-infrared light.

Table 13 shows the values of the parameters of the first to fourth embodiments defined in the conditions (1) to (6).

TABLE 13

| | Embodiment 1 | Embodiment 2 | Embodiment 3 | Embodiment 4 | |
|---|---|---|---|---|---|
| n d 1 | 1.750 | 1.749 | 1.834 | 1.788 | condition (1) |
| d 1/f | 0.198 | 0.196 | 0.198 | 0.201 | condition (2) |
| (nd 1/R 1)/f | 0.204 | 0.202 | 0.207 | 0.205 | condition (3) |
| (nd 1/R 2)/f | 0.039 | 0.038 | 0.054 | 0.051 | condition (4) |
| f 1/f | 0.569 | 0.569 | 0.579 | 0.586 | condition (5) |
| f 2/f | −1.036 | −1.045 | −1.020 | −1.020 | condition (6) |
| T T L/f | 1.230 | 1.222 | 1.237 | 1.297 | |

### REFERENCE SIGNS

LA: camera lens

STOP: aperture;

L1: first lens;

L2: second lens;

L3: third lens;

L4: fourth lens;

L5: fifth lens;

What is claimed is:

1. A camera lens, comprising, from an object side:
a first lens having a positive refractive power;
a second lens having a negative refractive power;
a third lens having a positive refractive power;
a fourth lens having a negative refractive power; and
a fifth lens having a negative refractive power,
wherein the camera lens satisfies following conditions:
1.75≤nd1≤1.84;
0.195≤d1/f≤0.210;
0.200≤(nd1/R1)/f≤0.210; and
0.035≤(nd1/R2)/f≤0.060,
where
nd1 denotes a refractive index of d line of the first lens;
d1 denotes a center thickness of the first lens;
f denotes a focal length of the camera lens;
R1 denotes a curvature radius of an object side surface of the first lens; and
R2 denotes a curvature radius of an image side surface of the first lens.

2. The camera lens as described in claim 1, further satisfying following conditions:
0.50≤f1/f≤0.60; and
−1.10≤f2/f≤−1.00,
where
f1 denotes a focal length of the first lens; and
f2 denotes a focal length of the second lens.
